(19) United States
(12) Patent Application Publication
(10) Pub. No.: US 2026/0323487 A1
(43) Pub. Date: Oct. 15, 2026

(54) DISCOVERY IN WTRU-TO-WTRU RELAYS

(71) Applicant: InterDigital Patent Holdings, Inc., Wilmington, DE (US)

(72) Inventors: Ananth Kini, Conshohocken, PA (US); Martino M. Freda, Laval (CA); Tuong Duc Hoang, Montreal (CA); Oumer Teyeb, Montreal (CA); Benoit Pelletier, Roxboro (CA)

(73) Assignee: InterDigital Patent Holdings, Inc., Wilmington, DE (US)

(21) Appl. No.: 19/116,491

(22) PCT Filed: Sep. 27, 2023
(86) PCT No.: PCT/US2023/033823

§ 371 Date: Mar. 28, 2025

Related U.S. Application Data
(60) Provisional application No. 63/410,782, filed on Sep. 28, 2022.
(60) Provisional application No. 63/421,449, filed on Nov. 1, 2022.
(60) Provisional application No. 63/421,534, filed on Nov. 1, 2022.

(51) Int. Cl. H04W 48/16; H04B 17/318

(52) U.S. Cl. CPC H04W 48/16; H04B 17/328

(57) ABSTRACT

A wireless transmit/receive node (WTRU) may be configured to receive an announcement message from another WTRU; determine, based on the announcement message, a list of source WTRUs; receive a discovery message from a source WTRU; compare the source WTRU to the list of source WTRUs; and determine, based on the comparison, whether to forward the discovery message.

### CROSS-REFERENCE TO RELATED APPLICATIONS

This application claims the benefit of Provisional U.S. Patent Application No. 63/410,782, filed Sep. 28, 2022, and Provisional U.S. Patent Application No. 63/421,534, filed Nov. 1, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein related to discovery in wireless transmit/receive unit (WTRU)-to-WTRU relays.

A first WTRU (e.g., a relay WTRU) may include a processor configured to perform one or more actions. The first WTRU may receive an announcement message from a second WTRU. The first WTRU may determine, based on the announcement message, a list of source WTRUs. The first WTRU may receive a discovery message from a source WTRU. The first WTRU may compare the source WTRU to the list of source WTRUs. The first WTRU may determine, based at least on the comparison, whether to forward the discovery message.

Determining, based at least on the comparison, whether to forward the discovery message may involve the first WTRU, on a condition that the source WTRU is not in the list of source WTRUs, determining to forward the discovery message and forward the discovery message to a remote WTRU.

Determining, based at least on the comparison, whether to forward the discovery message may involve the first WTRU, on a condition that the source WTRU is in the list of source WTRUs, determining whether to forward the discovery message further based on at least one of: a transmission characteristic of the discovery message or a location identifier of the source WTRU.

The transmission characteristic may be a minimum RSRP of the discovery message. Determining whether to forward the discovery message may involve the first WTRU, on a condition that the minimum RSRP of the discovery message is greater than a lowest RSRP indicated in the announcement message, determining to forward the discovery message, and forwarding the discovery message to a remote WTRU.

Determining whether to forward the discovery message may involve the first WTRU, on a condition that the location identifier of the source WTRU is different from a location ID of the first WTRU, determining to forward the discovery message, and forwarding the discovery message to a remote WTRU.

Determining whether to forward the discovery message may be further based on at least one of: a priority associated with the discovery message, or a quality of service associated with the discovery message.

The discovery message may be a first discovery message intended to be sent to a remote WTRU. The first WTRU may, on a condition that the first WTRU determines not to forward the first discovery message, generate a second discovery message associated with the first WTRU, and transmit the second discovery message to the remote WTRU.

### BRIEF DESCRIPTION OF THE DRAWINGS

Furthermore, like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a block diagram illustrating an example user plane protocol stack for L2 WTRU-to-Network relay.

FIG. 3 is a block diagram illustrating an example control plane protocol stack for L2 WTRU-to-Network relay.

FIG. 4 is a block diagram illustrating an example protocol stack of discovery messaging for L2 WTRU-to-Network relay.

FIG. 5 is a call flow diagram illustrating example WTRU-to-WTRU relay discovery signaling using Model A.

FIG. 6 is a call flow diagram illustrating example WTRU-to-WTRU relay discovery signaling using Model B.

FIG. 7 illustrates an example associated with a WTRU determining whether to forward a discovery message.

### DETAILED DESCRIPTION

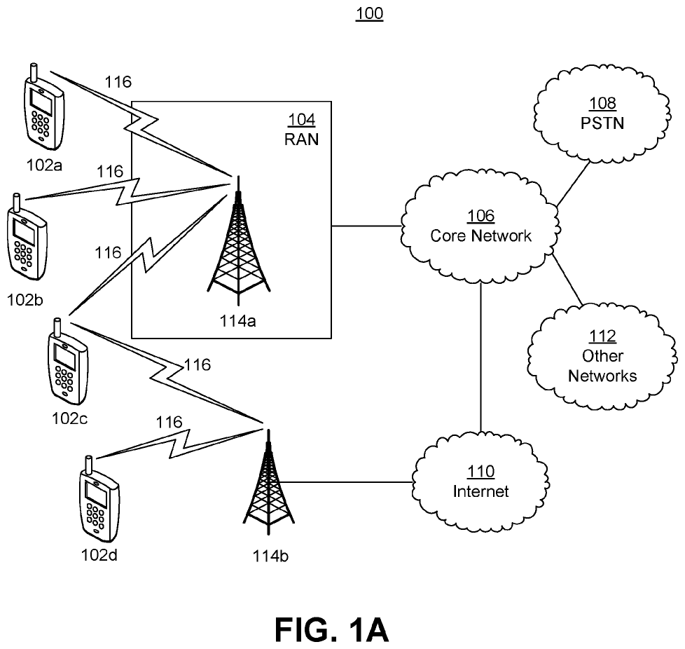

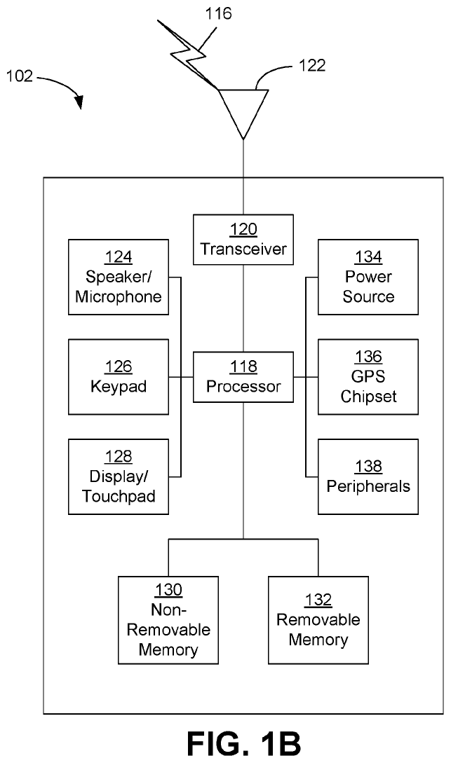

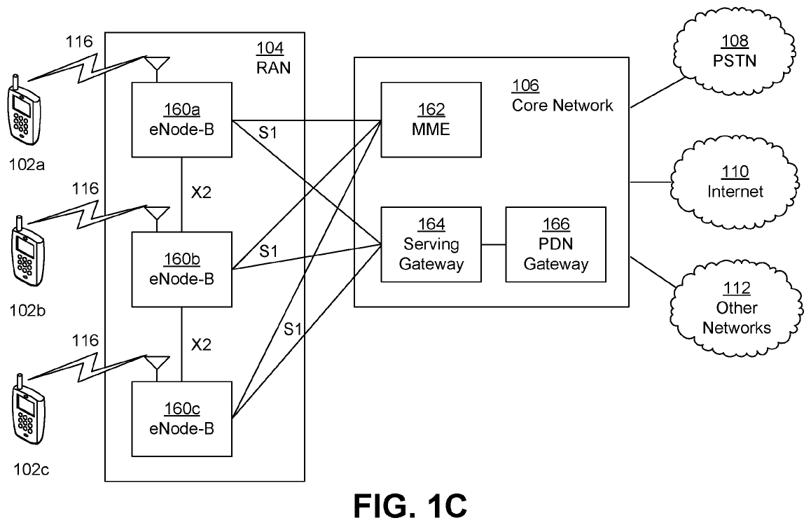

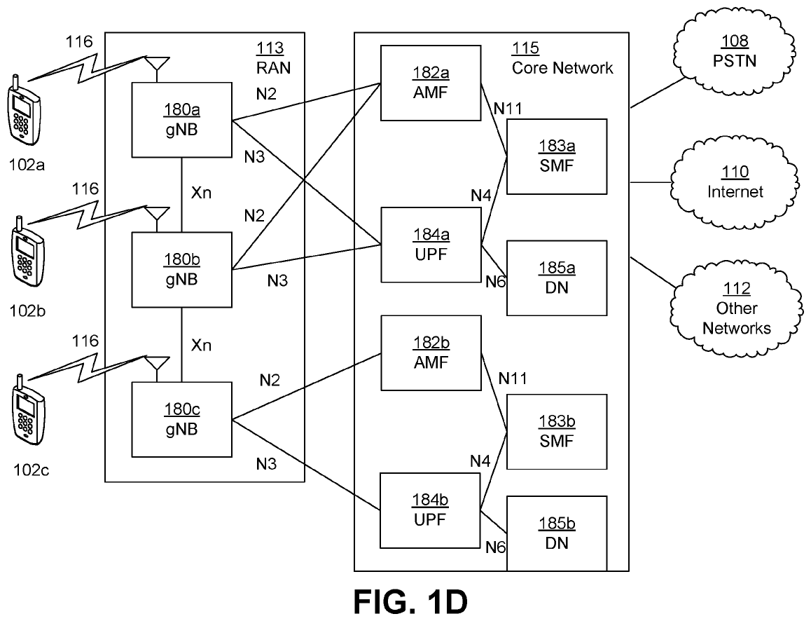

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102 c, 102 d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and EUTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating user equipment (UE) IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

WTRU-to-Network (W2N) relay(s) may be sidelink-based. Sidelink relay(s) may support 5G ProSe W2N relay(s). W2N relay(s) may provide connectivity to the network for W2N remote WTRU(s). Level 2 (L2) and level 3 (L3) W2N relay architectures may be supported. The L3 W2N relay architecture may be transparent to the serving RAN of the W2N relay WTRU (e.g., except for controlling sidelink resources).

A W2N relay WTRU may relay unicast data, for example, while being in RRC_CONNECTED state. If L2 W2N relay operation is used, one or more radio resource control (RRC) state combinations may be supported. For example, a W2N relay WTRU and a W2N remote WTRU may be in RRC CONNECTED to perform transmission/reception of relayed unicast data. The W2N relay WTRU may be in RRC_IDLE state, RRC_INACTIVE state, or RRC_CONNECTED state (e.g., as long as the W2N remote WTRU(s) that are connected to the W2N relay WTRU are either in RRC_INACTIVE state or in RRC_IDLE state).

For L2 W2N relay operation, the W2N remote WTRU may be (e.g., only be) configured to use resource allocation mode 2 for data to be relayed. A (e.g., single) unicast link may be established between a L2 W2N relay WTRU and a L2 W2N remote WTRU. Relay traffic (e.g., the traffic of the W2N remote WTRU sent via the W2N relay WTRU) and original traffic (e.g., traffic that originated at the W2N relay WTRU) may be separated into different Uu RLC channels (e.g., over a Uu interface).

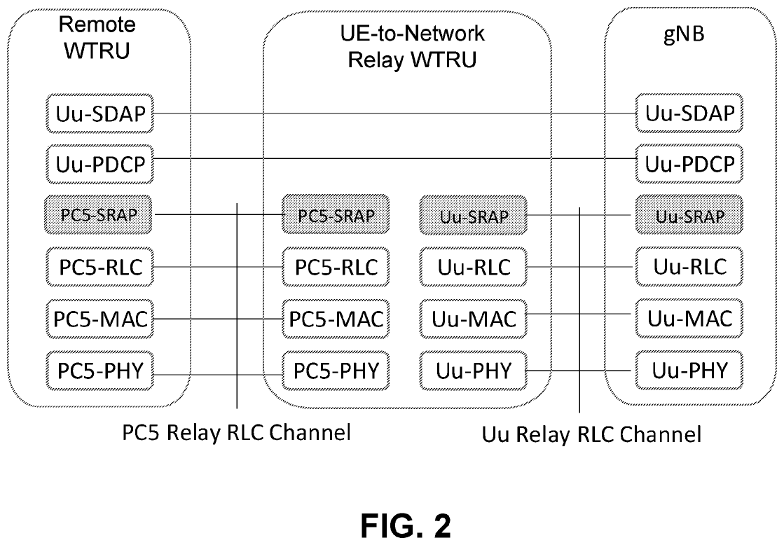

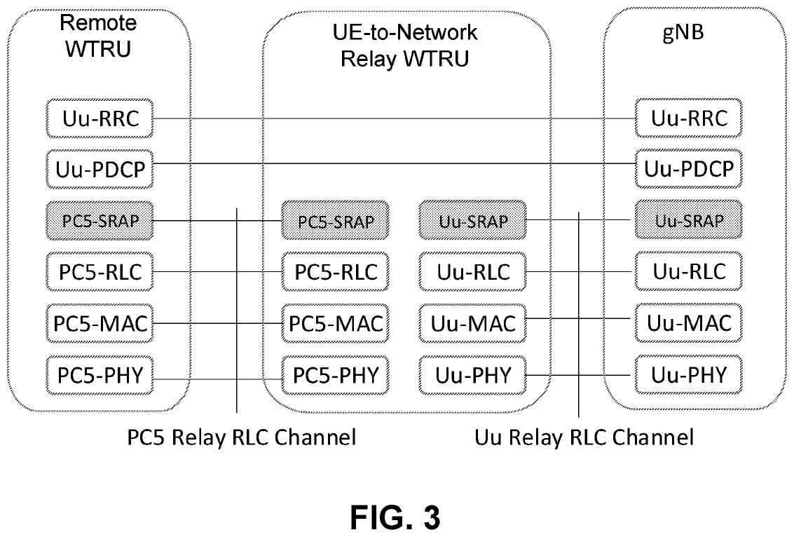

FIG. 2 illustrates an example of a user plane (UP) protocol stack for L2 W2 relay communication. FIG. 3 illustrates an example of a control plane (CP) protocol stack for L2 W2N relay communication. The sidelink relay adaptation protocol (SRAP) sublayer may be placed above the RLC sublayer in the CP and UP (e.g., at the PC5 interface of a remote WTRU and the Uu interface of a network node). For the L2 W2N relay, the adaptation layer may be placed over an RLC sublayer (e.g., in the CP and UP at the Uu interface between the relay WTRU and gNB). The Uu service data adaptation protocol/packet data convergence protocol (SDAP/PDCP) layer and RRC layer may be terminated between the served WTRU and gNB.

SRAP, RLC, MAC and PHY layers may be terminated in one or more links (e.g., each link between the served WTRU and W2N relay WTRU and the link between the W2N relay WTRU and the gNB). In examples, there may be an adaptation layer at the PC5 interface between the served WTRU and relay WTRU.

For the UL of the L2 W2N relay, the Uu adaptation layer at the relay WTRU may support an UL bearer mapping between ingress PC5 RLC channels for relaying and egress Uu RLC channels over the relay WTRU Uu path. For uplink relaying traffic, the different end-to-end radio bearers (RBs) (e.g., signaling radio bearers (SRB), data radio bearers (DRB)) of the same served WTRU or different served WTRUs may be subject to an N:1 mapping and data multiplexing over a Uu RLC channel. The Uu adaptation layer may be used to support served WTRU identification for the UL traffic (e.g., multiplexing the data coming from multiple served WTRUs). The identity information of a served WTRU Uu radio bearer and a served WTRU may be included in the Uu adaptation layer at the UL in order for the gNB to correlate the received data packets for the specific PDCP entity associated with the right served WTRU Uu radio bearer of a served WTRU.

For the DL of the L2 W2N relay, the Uu adaptation layer may be used to support DL bearer mapping at the gNB to map end-to-end RBs (SRB, DRB) of served WTRU to the Uu RLC channel over the relay WTRU Uu path. The Uu adaptation layer may be used to support DL N:1 bearer mapping and data multiplexing between multiple end-to-end Radio Bearers (SRBs, DRBs) of a served WTRU or different served WTRUs and a Uu RLC channel over the relay WTRU Uu path. The Uu adaptation layer may support a served WTRU identification for DL traffic. The identity information of the served WTRU Uu radio bearer and/or the identity information of the served WTRU may be put into the Uu adaptation layer by the gNB at the DL. The relay WTRU may use the identity information to map the received data packets from the served WTRU Uu radio bearer to its associated PC5 RLC channel. For an L2 W2N remote WTRU's message on an SRB (e.g., SRB0), the SRAP sublayer may not be present over a PC5 link. In some examples, the SRAP sublayer may be present over the Uu link (e.g., for both DL and UL).

A local remote WTRU ID may be included in a PC5 SRAP header. A local remote WTRU ID may be included in a Uu SRAP header. An L2 W2N relay WTRU may be configured by the gNB with a local remote WTRU ID (e.g., to be used in SRAP header). The remote WTRU may obtain the local remote ID from the gNB (e.g., via Uu RRC messages). Examples of RRC messages include RRCSetup, RRCReconfiguration, RRCResume and RRCReestablishment. Uu DRB(s) and/or Uu SRB(s) may be mapped to different PC5 relay RLC channels and/or Uu relay RLC channels (e.g., in the PC5 link and/or Uu link).

The gNB may take action to avoid collisions on the usage of local remote WTRU ID. The gNB may update the local remote WTRU ID. For example, the gNB may update the local remote WTRU ID by sending the updated local remote ID via an RRCReconfiguration message to the relay WTRU. The serving gNB may perform a local remote WTRU ID update independently from the PC5 unicast link L2 ID update procedure.

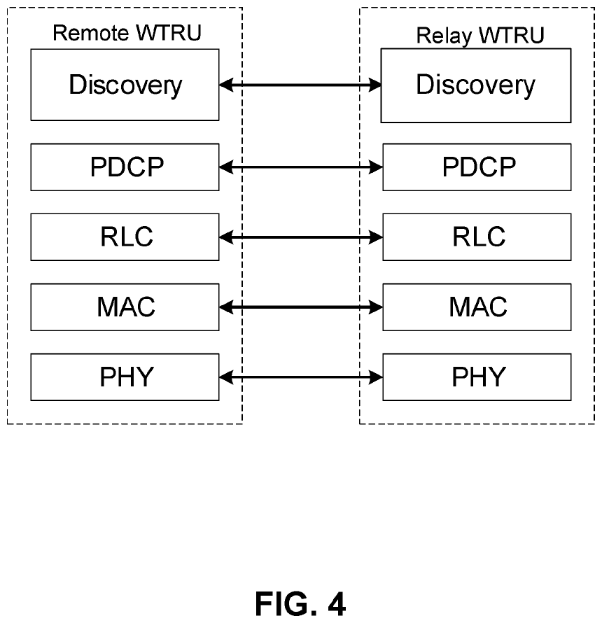

The W2N remote WTRU may perform relay discovery message transmission. The W2N remote WTRU may monitor the sidelink for relay discovery message (e.g., while in RRC_IDLE, RRC_INACTIVE, or RRC_CONNECTED). FIG. 4 is a block diagram illustrating an example protocol stack of discovery messaging for L2 W2N relay. The network may broadcast a threshold. The threshold may be used by the W2N remote WTRU, for example, to determine if the W2N remote WTRU can transmit relay discovery solicitation messages (e.g., sometimes referred to as solicitation messages) to W2N relay WTRU(s).

The W2N relay WTRU may perform relay discovery message transmission. The W2N relay WTRU may monitor the sidelink for relay discovery messages (e.g., while in RRC_IDLE, RRC_INACTIVE or RRC_CONNECTED). The network may broadcast a threshold. For example, the network may broadcast a maximum Uu reference signal received power (RSRP) threshold and/or a minimum Uu RSRP threshold. The W2N relay WTRU may use the threshold(s), for example, to determine if the W2N relay WTRU can transmit relay discovery messages to W2N remote WTRU(s).

The network may provide a relay discovery configuration. For example, the network may provide the relay discovery configuration using broadcast or dedicated signaling for relay discovery. The W2N remote WTRU and/or W2N relay WTRU may use pre-configuration for relay discovery.

The resource pool(s) used for NR sidelink communication may be used for relay discovery. In some examples, the network may configure one or more resource pool(s). The resource pool(s) may be dedicated for relay discovery. Resource pool(s) dedicated for relay discovery may be configured (e.g., simultaneously) with resource pool(s) for NR sidelink communication in system information, dedicated signaling, and/or pre-configuration. Whether a dedicated resource pool(s) for relay discovery is configured may be based on network implementation. For example, if resource pool(s) dedicated for relay discovery are configured, those resource pool(s) (e.g., only those resource pool(s)) dedicated for relay discovery may be used for relay discovery. For example, if resource pool(s) for NR sidelink communication (e.g., only resource pool(s) for NR sidelink communication) are configured, configured transmission resource pool(s) (e.g., all configured transmission resource pool(s)) may be used for relay discovery and/or sidelink communication.

For a W2N remote WTRU (e.g., including both in-coverage and out-of-coverage cases) that has been connected to the network via a W2N relay WTRU, resource allocation mode 2 may be used for discovery message transmission.

Examples of relay (re)selection are provided herein. The W2N remote WTRU may perform radio measurements at PC5 interface. The W2N remote WTRU may use the radio measurements for W2N relay selection and/or reselection (e.g., along with higher layer criteria). In examples, the W2N remote WTRU may use sidelink discovery RSRP (SD-RSRP) measurements to evaluate whether PC5 link quality towards a W2N relay WTRU satisfies relay selection criterion. For example, the W2N remote WTRU may use SD-RSRP measurements to evaluate PC5 link quality (e.g., if there is no unicast PC5 connection between the W2N relay WTRU and the W2N remote WTRU).

In some examples (e.g., for relay reselection), the W2N remote WTRU may use sidelink RSRP (SL-RSRP) measurements towards the serving W2N relay WTRU for relay reselection trigger evaluation. For example, the W2N remote WTRU may use SL-RSRP measurements towards the serving W2N relay WTRU for relay reselection trigger evaluation if there is data transmission from W2N relay WTRU to W2N remote WTRU. For example, the W2N remote WTRU may use SL-RSRP measurements towards the serving W2N relay WTRU for relay reselection trigger evaluation if WTRU implementation controls whether to use SL-RSRP or SD-RSRP for relay reselection trigger evaluation in case of no data transmission from W2N relay WTRU to W2N remote WTRU.

A W2N relay WTRU may be considered suitable by a W2N remote WTRU if certain criteria are met. For example, the W2N relay WTRU may be considered suitable by a W2N remote WTRU if the PC5 link quality measured by W2N remote WTRU towards the W2N relay WTRU exceeds a configured threshold (e.g., pre-configured or provided by gNB). The W2N remote WTRU may search for suitable W2N relay WTRU candidates that meet access stratum (AS) layer and higher layer criteria (e.g., all AS layer and higher layer criteria). If there are multiple such suitable W2N relay WTRUs, the W2N remote WTRU may determine (e.g., via W2N remote WTRU implementation) to choose one W2N relay WTRU from among them. For L2 W2N relay (re-)selection, the PLMN ID and cell ID may be used as AS criteria.

The W2N remote WTRU may trigger W2N relay selection in some cases. For example, the W2N remote WTRU may trigger W2N relay selection if the direct Uu signal strength of a cell (e.g., the current serving cell) of the W2N remote WTRU is below a threshold (e.g., a configured signal strength threshold). For example, the W2N remote WTRU may trigger W2N relay selection if it receives an indication from an upper layer of the W2N remote WTRU.

The W2N remote WTRU may trigger W2N relay reselection in some cases. For example, the W2N remote WTRU may trigger W2N relay reselection if PC5 signal strength of current W2N relay WTRU is below a threshold (e.g., a (pre)configured signal strength threshold). For example, the W2N remote WTRU may trigger W2N relay re-selection if cell (re)selection, handover, and/or Uu radio link failure (RLF) has been indicated by a W2N relay WTRU (e.g., via PC5-RRC signaling). The W2N remote WTRU may trigger W2N relay reselection if the remote WTRU receives a PC5-S link release message (e.g., from the W2N relay WTRU). The W2N remote WTRU may trigger W2N relay reselection if the W2N remote WTRU detects PC5 RLF. The W2N remote WTRU may trigger W2N relay reselection if the W2N remote WTRU receives an indication to do so (e.g., by an upper layer).

For L2 W2N remote WTRUs in RRC_IDLE/INACTIVE and/or L3 W2N remote WTRUs, the cell (re)selection procedure and relay (re)selection procedure may run independently. If suitable cells and suitable W2N relay WTRUs are available, WTRU implementation may determine to select either a cell or a W2N relay WTRU. A L3 W2N remote WTRU may select a cell and a W2N relay WTRU (e.g., simultaneously). L3 W2N remote WTRU implementation may determine whether the L3 W2N remote WTRU selects a cell and/or a W2N relay WTRU.

The PC5-RRC message(s) may be used (e.g., for L2 and L3 W2N relay WTRUs in RRC_IDLE/INACTIVE) to inform their connected remote WTRU(s) if W2N relay WTRUs select a new cell. The PC5-RRC message(s) may be used to inform their connected L2 or L3 W2N remote WTRU(s) if L2/L3 W2N relay WTRU performs handover or detects Uu RLF. Upon reception of the PC5 RRC message for notification, W2N remote WTRU implementation may determine whether to release or keep the unicast PC5 link. If the W2N remote WTRU determines to release the unicast PC5 link, it may trigger the L2 release and relay reselection.

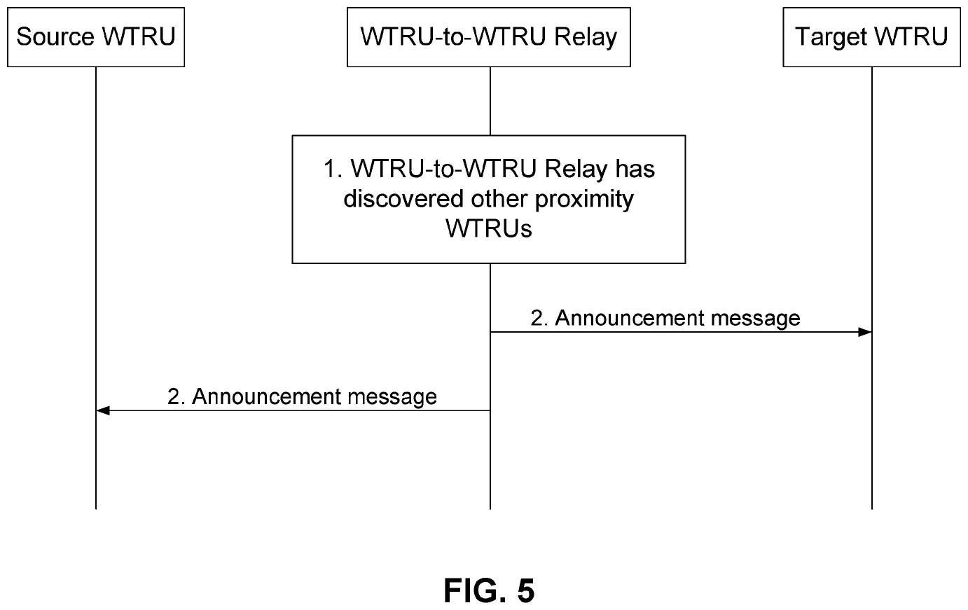

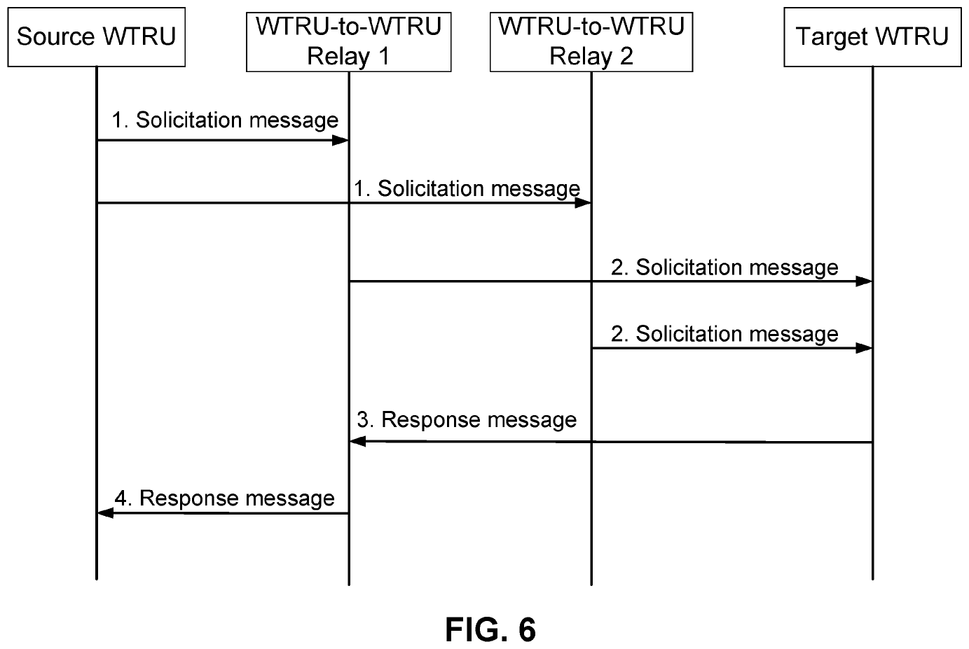

W2N relay procedures may use two models (e.g., Model A and B) for discovery and/or relay (re)selection. For example, in Model A, a W2N relay WTRU may send announcement message(s). FIG. 5 is a call flow diagram illustrating example WTRU-to-WTRU relay discovery signaling using Model A. For example, in Model B, a W2N remote (e.g., source) WTRU may send solicitation message(s) (e.g., to ask for a relay service from a relay WTRU). W2N relays may respond to the solicitation message(s) from the remote WTRUs. FIG. 6 is a call flow diagram illustrating example WTRU-to-WTRU relay discovery signaling using Model B.

W2N relays may be located in between a remote WTRU and a network node. For example, the remote WTRU may be (e.g., may be assumed to be) out of coverage. The relay WTRU may be (e.g., may be assumed to be) in coverage. The remote WTRU may have (e.g., may be assumed to have) a single unicast link with the relay WTRU. The relay WTRU may have an RRC connection with the network.

WTRU-to-WTRU (W2W) relays may have variations of topology and coverage situations other than those described herein. For example, one or more (e.g., all) of the WTRUs may be in coverage or out of coverage, and/or operating in mode 1/mode2, with resource pool configuration. For example, the same or different relay WTRUs may serve a single source WTRU with multiple connections to different destinations (e.g., or vice versa). A WTRU may use a W2N relay and/or a W2W relay.

Some situations may cause a high number of discovery message transmissions. The high number of discovery message transmissions may lead to a congestion of discovery (pool) related resources. The high number of discovery message transmissions may result in sub-optimal W2W relay selection.

Conditions (e.g., criteria) for discovery message forwarding/transmissions are disclosed herein. For example, the conditions may reduce (e.g., limit) the number of discovery message transmissions. For example, the techniques described herein may reduce the number of discovery message transmissions (e.g., unnecessary discovery message transmissions), reduce signaling overhead/resource usage, and/or enable selection of a preferred relay path (e.g., via reliable source/remote WTRUs).

A WTRU (e.g., a first relay WTRU) may transmit (or forward) a discovery message based on discovery message monitoring and/or link measurements. In some examples, the first relay WTRU may determine whether to transmit/forward a discovery message based on the presence of certain information contained in discovery message(s) (e.g., received from another relay WTRU, referred to herein as a second relay WTRU). The first relay WTRU may determine whether to transmit/forward a discovery message based on discovery message forwarding rules/criteria. The discovery message(s) may be based on Model A and model B type messages.

The second relay WTRU may transmit a discovery message (e.g., announcement message) that includes a list of reachable WTRUs (e.g., reachable source WTRUs). The second relay WTRU may transmit a discovery message that includes a list of WTRUs (e.g., source WTRUs) that the second relay WTRU has successfully discovered. For example, the second relay WTRU may receive discovery solicitation message(s) from one or more source WTRUs. The second relay WTRU may add the identity (e.g., L2 ID, source WTRU ID, etc.) of such source WTRU(s) to the discovery message. As used herein, the term “source WTRU” may refer to a WTRU that is the source of a discovery message (e.g., to the first relay WTRU or to the second relay WTRU). A source WTRU may be a remote WTRU.

The second relay WTRU may determine which source WTRU ID(s) are included in the discovery message. The determination may be based on one or more conditions.

An example condition may be a condition of time. For example, the second relay WTRU may include source WTRU IDs (e.g., only source WTRU IDs) for source WTRUs that have transmitted at least one solicitation message in the last N seconds. In some examples, N may be a (pre)configured value.

An example condition may be a condition of channel quality. For example, the second relay WTRU may include source WTRU IDs (e.g., only source WTRU IDs) for source WTRUs with SD-RSRP that is above a (pre)configured threshold. A condition of channel quality may be combined with a condition of time or other condition. For example, the second relay WTRU may include source WTRU IDs (e.g., only source WTRU IDs) for source WTRUs with SD-RSRP that is above a (pre)configured threshold, for example, during the last Q seconds.

An example condition may be related to a number of source WTRUs. For example, the second relay WTRU may include a number (e.g., a maximum) of M source WTRUs. In some examples, M may be determined based on channel busy ratio (CBR), channel occupancy ratio (CR), relay load, relay capability, and/or other measurements and/or rules (e.g., which may be (pre)configured at the relay or predetermined).

An example condition may be a condition of location. For example, the second relay WTRU may receive location information from a source WTRU in the source WTRU's discovery solicitation message.

For example, the second relay WTRU may include source WTRU IDs (e.g., only source WTRU IDs) for source WTRUs that are a certain distance from the second relay WTRU. For example, source WTRUs may be included if their distance from the second relay WTRU is above a first threshold and/or below a second threshold. The distance may be calculated using the zone ID transmitted by the source WTRU. The distance may be calculated using the actual coordinates of the source WTRU and the second relay WTRU.

An example condition may be a condition related to a resource pool. For example, the second relay WTRU may receive a solicitation message from a source WTRU in either a dedicated resource pool or a shared resource pool. The second relay WTRU may determine whether to include the source WTRU in the announcement message depending on whether the source WTRU can perform transmission on the same pool (e.g., dedicated and/or shared).

The second relay WTRU may include information associated with each source WTRU in the announcement message. For example, the announcement message may include a WTRU ID of the source WTRU (e.g., L2 ID, source WTRU ID, etc.), RSRP of the measured source WTRU, an indication that there is (e.g., already) a link (e.g., a PC5-RRC connection) with one or more source WTRUs (e.g., in the list of source WTRUs), an indication of whether the source WTRU has a PC5-RRC connection with the second relay WTRU, and/or a corresponding L2 ID associated with that unicast link.

The announcement message may include a coverage status of the source WTRU(s). The coverage status may be received from the source WTRU(s). The coverage status may include information such as: whether the source WTRU is in or out of network coverage, whether the source WTRU is Uu connected, IDLE, INACTIVE (e.g., the Uu RRC state of each source WTRU), whether the source WTRU is using a WTRU-to-Network relay, and/or the cell/relay to which the source WTRU is connected.

The second relay WTRU may send SL-RSRP and/or SD-RSRP in the announcement message (e.g., to one or more other WTRUs, for example, remote WTRUs). The second relay WTRU may use criteria to decide which measurement(s) (e.g., SL-RSRP and/or SD-RSRP) to include in the announcement message if both measurements are available. For example, the second relay WTRU may send SL-RSRP (e.g., either on its own or in addition to SD-RSRP) if data is available between a source WTRU and the second relay WTRU. Otherwise (e.g., if data is not available between a source WTRU and the second relay WTRU), the second relay WTRU may send SD-RSRP. For example, the second relay WTRU may (e.g., always) send SL-RSRP (e.g., only SL-RSRP) if both measurements are available.

If both measurements are available, the second relay WTRU may determine to send one (e.g., only one) of the measurements (e.g., to the one or more other WTRUs). The decision of which measurement to send may be based on a relative measurement of the two measurements. For example, the decision of which measurement to send may be based on the minimum, maximum, or average of the two measurements. In some examples, the decision of which measurement to send may be based on a type of service (e.g., QoS and/or reliability, etc.).

In some examples, the decision of which measurement to include in the announcement message may be based on the frequency and/or age (e.g., the relative frequency and/or age) of the measurements. For example, if the last available SL-RSRP is within the last x seconds, then the second relay WTRU may choose to include SL-RSRP over SD-RSRP. In an example, if the last available SL-RSRP is more recent or within some relative time duration of the SD-RSRP measurement, then the second relay WTRU may choose to include SL-RSRP over SD-RSRP. The second relay WTRU may decide which measurement to send based on any combination of the criteria described herein.

The second relay WTRU may send information indicating that there is (e.g., already) a link (e.g., a PC5-RRC connection) with one or more source WTRUs (e.g., in the list of source WTRUs). For example, the second relay WTRU may send an explicit indication (e.g., via a flag in the discovery message, via a field in a MAC CE, and/or via a dedicated MAC CE) that the link exists. In some example, the indication may be implicit. For example, the second relay WTRU may send SL-RSRP if a link (e.g., a PC5-RRC connection) exists. The second relay WTRU may send SD-RSRP if a link (e.g., a PC5-RRC connection) does not exist. The second relay WTRU may send SL-RSRP and SD-RSRP if a link (e.g., a PC5-RRC connection) exists.

The second relay WTRU may include information associated with the second relay WTRU in the announcement message. For example, the announcement message may include one or more of the following: a WTRU ID of the second relay WTRU, PC5 unicast links currently established at the second relay WTRU (e.g., the L2 IDs of the peer WTRUs of such unicast links), a location of the second relay WTRU (e.g., using coordinates and/or a zone ID in which the second relay WTRU resides).

Another WTRU (e.g., a remote WTRU, which may be referred to as a responding WTRU) may choose to respond to (e.g., select) relay WTRU announcement message(s) that the source WTRU can use to perform relay WTRU selection. For example, the responding WTRU may respond to (e.g., send the discovery response or select a relay WTRU to) relay WTRUs (e.g., only relay WTRUs) with a SL-RSRP measurement (e.g., received from the relay WTRU's broadcasted announcement message). If the responding WTRU receives an announcement message with SL-RSRP from a relay WTRU, the responding WTRU may choose to respond based on whether the SL-RSRP measurement is above a threshold. The responding WTRU may choose to respond to (e.g., only to) the relay WTRU with the best (e.g., highest) SL-RSRP measurement. The responding WTRU may respond to relay WTRUs (e.g., all relay WTRUs) with SL-RSRP and relay WTRUs with SD-RSRP.

The responding WTRU may respond to a fixed number of relay WTRUs. For example, the responding WTRU may prioritize relay WTRUs with SL-RSRP measurement(s). The responding WTRU may respond to relay WTRUs with (e.g., only) SD-RSRP. For example, the responding WTRU may shortlist (e.g., only) relay WTRUs with SD-RSRP over a threshold. The threshold may be adjusted. For example, the threshold may be adjusted based on (e.g., additional) criteria (e.g., relay service needs). The threshold may be adjusted based on a (e.g., guaranteed) minimum or maximum number of relay WTRUs from which the responding WTRU may select.

The responding WTRU may select a relay WTRU to which to respond based on whether the relay WTRU indicates that a link exists with a peer WTRU. For example, a responding WTRU may respond (e.g., only) to relay WTRUs that indicate an existing link (e.g., if such a relay WTRU is present). For example, the responding WTRU may prioritize relay WTRUs with an existing link (e.g., by applying a bias in the measurements and selecting the relay WTRU that indicates the best measurements).

A responding WTRU (e.g., a target WTRU) may include information in a response message (e.g., sent to one or more other WTRUs). The information may be similar to the information transmitted for relay WTRU announcement. The information may be based on whether SL-RSRP and/or SD-RSRP are available. For example, the responding WTRU may send (e.g., only) SL-RSRP if both measurements are available. The responding WTRU may send (e.g., only) SD-RSRP if both measurements are available. The responding WTRU may send (e.g., only) one of SL-RSRP and SD-RSRP if both measurements are available. The decision of which measurement to send may be based on relative measurements of the two measurements. For example, the decision of which measurement to send may be based on the minimum, maximum, average, etc. of the two measurements. The choice of which statistical measure (e.g., minimum, maximum, average, etc.) to use may be based on type of service (e.g., QoS, reliability, etc.) as indicated in the source WTRU solicitation message.
responding WTRUs (e.g., source WTRUs) may (re)select relay WTRU(s). For example, the responding WTRUs may (re)select a relay WTRU based on information in the relay WTRU's discovery (e.g., announcement) message. For example, the announcement message may include information such as the L2 ID of reachable source WTRUs, and/or measurement information (e.g., SL-RSRP and/or SD-RSRP) related to the source WTRUs, as described herein. Similarly, the responding WTRU may trigger relay (re)selection based on information in the discovery message and/or measurements by the responding WTRU or the relay WTRU.

A responding WTRU may check to see if the announcement message includes the L2 ID of the target/peer WTRU with which the responding WTRU is trying to communicate. Conditions for the link between the relay WTRU and the target/peer WTRU (e.g., based on information in the announcement message) and/or conditions for the link between the responding WTRU and the relay WTRU (e.g., based on measurement of discovery) may be considered (e.g., separately or in combination).

The relay WTRU may be selected based on the link between the relay WTRU and the target/peer WTRU (e.g., based on information in the announcement message). For example, if SL-RSRP and SD-RSRP are included in the announcement message, the relay WTRU may be selected based on whether the SL-RSRP and SD-RSRP are above a threshold. The threshold may be a single threshold for both measurements, or different thresholds for each of the measurements. The relay WTRU may be selected based on whether either SL-RSRP or SD-RSRP are above a threshold. The relay WTRU may be selected based on a statistical measure (e.g., minimum, maximum, average, etc.) of the SL-RSRP and/or the SD-RSRP being above a threshold.

The relay WTRU may be selected based on the link between the responding (e.g., source) WTRU and the relay WTRU. For example, the relay WTRU may be selected based on whether SL-RSRP (if available) and/or SD-RSRP (if available) is above a threshold.

The responding (e.g., source) WTRU may combine multiple (e.g., two) link measurements to determine whether to select a given relay WTRU and/or whether to trigger relay WTRU selection. For example, the responding WTRU may determine whether to select the relay WTRU based on a received measurement (e.g., in the announcement message from the relay WTRU) and a measurement measured by the responding WTRU. The combination of the measurements (e.g., the received and measured measurements) may be based on whether the measurements are SL-RSRP measurements or SD-RSRP measurements. For example, the rule for selection (or for triggering reselection) may be different if SL-RSRP is available on either of the two links (e.g., compared to if SL-RSRP is not available).

For example, if SL-RSRP is received in a relay WTRU's announcement message and measured SL-RSRP is available, the two SL-RSRP measurements may be combined (e.g., averaged). The responding WTRU may determine whether the combined SL-RSRP measurement is above a threshold. In an example, if SD-RSRP is received in a relay WTRU's announcement message and measured SD-RSRP is available, the SD-RSRP measurements may be combined (e.g., averaged). The responding WTRU may determine whether the combined SD-RSRP measurement is above a threshold.

If the same measurement type (e.g., SL-RSRP or SD-RSRP) is available on multiple (e.g., two separate) links, the responding WTRU may combine (e.g., average) the measurements. The responding WTRU may determine whether the combined measurement is above a threshold. If the same measurement type (e.g., SL-RSRP or SD-RSRP) is available on multiple (e.g., two separate) links, the responding WTRU may determine whether each measurement is above the threshold. If the same measurement type (e.g., SL-RSRP or SD-RSRP) is available on multiple (e.g., two separate) links, the responding WTRU may determine whether at least one of the measurements is above the threshold.

The link between a responding (e.g., source) WTRU and a relay WTRU may be referred to as a first hop. The link between a relay WTRU and a target WTRU (e.g., another WTRU, such as a remote WTRU) may be referred to as a second hop. If the SL-RSRP measurement is available on a second hop, the responding WTRU may (e.g., only) consider criteria of a first hop. For example, the responding WTRU may consider whether the SL-RSRP or SD-RSRP of the first hop is above a threshold. Otherwise, if SL-RSRP is not available on the second hop (e.g., only SD-RSRP is available), the responding WTRU may consider whether the SD-RSRP (e.g., possibly of both hops) is above a threshold.

If SL-RSRP and SD-RSRP measurements are available on the second hop, the responding WTRU may use the measurement (e.g., only the measurement) of the second hop (e.g., SL-RSRP or SD-RSRP) that matches the measurement that is available on the first hop, or that is used on the first hop.

If SL-RSRP is available on the first hop, the responding WTRU may use SL-RSRP (e.g., only SL-RSRP), if it is available, on the second hop. Otherwise, the responding WTRU may not use any measurement related to the second hop.

The responding WTRU may trigger relay (re)selection based on the combination of the link measurements. The combination may involve combining the measurements of the two links, or deciding which of SL-RSRP or SD-RSRP to use on one or more links based on the availability of this measurement on one or both links. If SL-RSRP of the relay WTRU is available at the responding WTRU, the responding WTRU may trigger reselection if either SL-RSRP of the relay WTRU or SL-RSRP between the relay WTRU and the destination WTRU (if available) is below a threshold value. If SL-RSRP of the relay WTRU is not available at the responding WTRU, the responding WTRU may trigger relay reselection if the SD-RSRP of the relay WTRU or the SD-RSRP between the relay WTRU and destination WTRU is below a threshold.

A responding WTRU may prioritize selection of relay WTRUs with which there is a link (e.g., already) available. For example, the responding WTRU may prioritize these relay WTRUs by applying an offset bias. The responding WTRU may prioritize these relay WTRUs by (e.g., always) selecting a relay WTRU when the SD-RSRP from that relay WTRU is greater than a threshold.

The relay WTRU selection may occur on the second hop. In this case, the responding WTRU may select a relay WTRU with SL-RSRP available in the announcement message or with an existing link with the responding WTRU. The responding WTRU may select a relay WTRU (e.g., only) if conditions related to a threshold are satisfied. If no relay WTRU has SL-RSRP available in the announcement message, the responding WTRU may select a relay WTRU (e.g., any relay WTRU) where conditions (e.g., other conditions related to the threshold) are satisfied.

The relay WTRU selection may occur on the first hop. For example, the responding WTRU may select a relay WTRU if data is available (e.g., with SL-RSRP or SD-RSRP available in the announcement message). Otherwise, the responding WTRU may select another relay WTRU (e.g., any other relay WTRU) that satisfies other conditions.

A relay WTRU may respond to a responding WTRU. The response may ensure discovery transmissions that are updated, accurate, and/or consistent. The response may ensure that relay (re)selection is updated, accurate, and/or consistent.

A source WTRU (e.g., in this case, a WTRU that has selected a relay WTRU and is sending discovery messages via the relay WTRU) may sense an issue with the link between the source WTRU (e.g., itself) and a serving relay WTRU. For example, the source WTRU may sense that RSRP (e.g., SL-RSRP and/or SD-RSRP) has dropped below a threshold. The sensed issue may trigger relay reselection. In this case, the source WTRU may send a solicitation message. If another WTRU (e.g., the target WTRU to which the source WTRU is attempting to send a message) does not send a solicitation message, relay WTRUs in the vicinity of the source WTRU may not be able to include the source WTRU in an announcement message.

The relay WTRU may send a message (e.g., a PC5-RRC message) that triggers discovery. For example, a relay WTRU may send a PC5-RRC message to a source WTRU if the relay WTRU's link with another source WTRU has measurements (e.g., SL-RSRP and/or SD-RSRP) that are below a threshold (e.g., if the relay WTRU detects that the measurements are below the threshold). For example, a relay WTRU may send a PC5-RRC message to a source WTRU (e.g., to ask the source WTRU to transmit solicitation) if the relay WTRU detects discovery message(s) from another source WTRU. A relay WTRU may send a PC5-RRC message to a source WTRU if the relay WTRU receives measurement reporting from another source WTRU that indicates that the reported measurement(s) (e.g., SL-RSRP and/or SD-RSRP) are below a threshold.

A source WTRU may determine transmission behavior of a solicitation based on an indicated value of the measurement(s). For example, if SL-RSRP is relatively small (e.g., low), the source WTRU may transmit solicitation messages more frequently. The source WTRU may change (e.g., modify) the discovery transmission behavior upon receiving the PC5-RRC message from the relay WTRU.

A source WTRU may determine a discovery transmission behavior. For example, the source WTRU may (e.g., upon receiving a PC-RRC message from a relay WTRU) trigger a discovery transmission (e.g., a step 1 discovery message transmission). For example, the source WTRU may (e.g., upon receiving a step 2 announcement message from a connected relay WTRU) trigger a discovery transmission (e.g., a step 1 discovery message transmission). The current relay WTRU may use the discovery messages to announce the source WTRU being served to other potential relay WTRUs. A potential relay WTRU (e.g., only a potential relay WTRU that serves the source WTRU) may be selected as the new serving relay WTRU.

The PC5-RRC message (e.g., that the relay WTRU sends to trigger a discovery message) may be triggered by the source WTRU. For example, the source WTRU (e.g., connected to a relay WTRU) may determine that a measured link with the relay WTRU is below a threshold, may not have data to send to the relay, and/or may not be transmitting a discovery message. In this case, the source WTRU may initiate a discovery transmission and/or transmit a PC5-RRC message to the relay WTRU.

The relay WTRU may (e.g., upon receiving a PC5-RRC message from a source WTRU) send a PC5-RRC message to one or more other WTRUs connected to the source WTRU. The PC5-RRC message sent by the relay WTRU may include measurements (e.g., taken by the relay WTRU) of the source WTRU. The PC5-RRC message sent by the relay WTRU may include measurements made by the source WTRU that were included in the initial PC5-RRC message received by the relay WTRU.

A discovery message transmission may depend on a discovery source WTRU list.

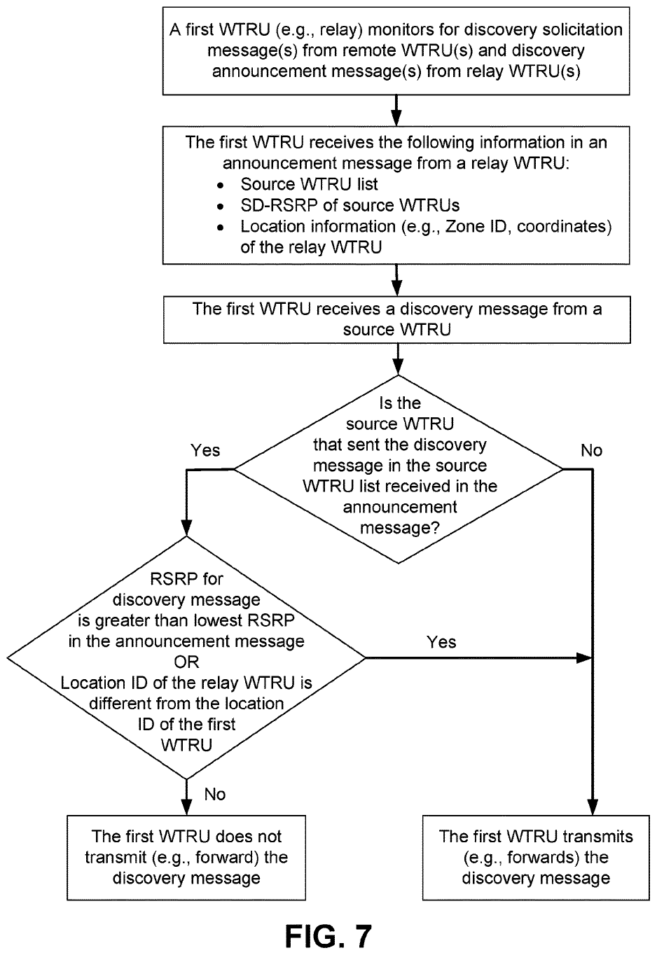

A WTRU (e.g., a first relay WTRU) may determine whether to monitor discovery transmissions from other WTRUs. The first relay WTRU may monitor announcement messages from other relay WTRUs (e.g., as shown in FIG. 7). The first relay WTRU may monitor discovery messages from source WTRUs.

The first relay WTRU may receive and/or decode the announcement messages from the a second relay WTRU (e.g., based on one or more conditions). The first relay WTRU may monitor for/receive discovery message(s) from source WTRU(s) (e.g., as shown in FIG. 7). The first relay WTRU may determine whether to forward source WTRU discovery messages and/or transmit its own discovery message (e.g., announcement message), for example, based on one or more conditions. The one or more conditions may be associated with the contents of the announcement messages from other relays and/or the discovery message(s) received from the source WTRU(s).

An example condition may be a condition related to the presence of a source WTRU (e.g., a WTRU from which a discovery message is received, for example as described herein) in a list of source WTRUs (e.g., as shown in FIG. 7). The list of source WTRUs may be received from one or more other relay WTRUs (e.g., a second relay WTRU). For example, the first relay WTRU may forward a discovery message from a source WTRU or transmit an announcement message (e.g., its own announcement message) based at least on whether the source WTRU from which the first relay WTRU receives the discovery message is listed in the list of source WTRUs (e.g., which was received from the second relay). If the first relay WTRU determines not to forward the discovery message from the source WTRU, the first relay WTRU may generate a second discovery message associated with the first relay WTRU (e.g., its own discovery message) and transmit the second discovery message (e.g., to a source WTRU or another relay WTRU). FIG. 7 is a WTRU (e.g., the first relay WTRU) determining whether to forward a discovery message based on a list of source WTRUs.

An example condition may be a condition associated with the discovery RSRP (e.g., received from a source WTRU). The condition may be based on a comparison of the discovery RSRP to a reported RSRP (e.g., reported with or in the list of source WTRUs). For example, the first relay WTRU may transmit an announcement message (e.g., its own announcement message) if the measured SD-RSRP of at least one source WTRU is above a first threshold and/or below a second threshold. For example, the first relay WTRU may transmit (e.g., forward) a received announcement message if the measured SD-RSRP of at least one source WTRU is better than the announced SD-RSRP of that source WTRU (e.g., received from the second relay WTRU's announcement message).

An example condition may be a condition associated with the location of the first relay WTRU.

For example, the location of the first relay WTRU may be compared with the location of the second relay WTRU. The first relay WTRU may transmit an announcement message (e.g., its own announcement message) if the distance between the first relay WTRU and the second relay WTRU is below a threshold.

More than one condition may be combined to determine whether (or when) to transmit (e.g., forward) an announcement message from a source WTRU. For example, the determination may be based on whether the source WTRU is in the list of source WTRUs and at least one of: a transmission characteristic of the discovery message or a location identifier of the source WTRU, as described herein (e.g., as shown in FIG. 7). For example, if the source WTRU is in the list of source WTRUs, the determination may be further based on the transmission characteristic of the discovery message or the location identifier of the source WTRU (e.g., as shown in FIG. 7).

For example, the second relay WTRU may identify a list of WTRUs (e.g., source WTRUs) that are reachable by the first relay WTRU from which the second relay WTRU has received a first discovery message (e.g., based on the first relay's list of source WTRUs). The second relay WTRU may perform a discovery procedure to determine the list of reachable source WTRUs. The second relay WTRU may include (e.g., in a second announcement message) the list of discovered source WTRUs. The second relay WTRU may include, in the second discovery message, the source WTRUs (e.g., source WTRUs) that the second relay WTRU was able to discover. The second relay WTRU may include, in the second discovery message, the source WTRUs (e.g., only the source WTRUs) with a respective measurement above a threshold (e.g., a measurement associated with a source WTRU is above a threshold in order for a source WTRU to be included).

The first relay WTRU may determine the list of source WTRUs based on the announcement message. As illustrated in FIG. 7, the first relay WTRU may compare the list of source WTRUs (e.g., received from the second relay WTRU) with source WTRUs from which the first relay WTRU has received discovery messages. The first relay WTRU may determine, based on the comparison, whether to forward the discovery message (e.g., as shown in FIG. 7). For example, the first relay WTRU may or may not perform relay functionalities for the source WTRU, for example based on condition(s) described herein.

The source WTRUs from which the first relay WTRU has received discovery messages may be compared to the list of source WTRUs (e.g., as shown in FIG. 7) by comparing WTRU-specific identifiers (IDs). Example identifiers may include Layer-2 IDs, radio network temporary identifier (RNTI), cell RNTI (C-RNTI), and/or other NW-assigned ID (e.g., a temporary ID). In some examples, the number of source WTRUs may not match. For example, the first relay WTRU may receive a discovery message from a source WTRU, where the source WTRU is not included in the list of source WTRUs transmitted by the second relay WTRU. In this case, the first relay WTRU may determine to forward the discovery message from the source WTRU (e.g., as shown in FIG. 7).

The number of source WTRUs in the list may be more than the number of WTRUs from which the first relay WTRU receives discovery messages. In this case, the first relay WTRU may choose to forward the source relay's discovery (e.g., announcement) message. If the number of source WTRUs in the list are more than the number of WTRUs from which the first relay WTRU receives discovery messages, the first relay WTRU may decide to transmit a discovery message including the list of source WTRUs that the first relay WTRU has discovered based on reception of discovery messages from the source WTRUs.

The first relay WTRU that receives a solicitation message (e.g., a Model B solicitation message) from a source WTRU may use one or more condition(s) to determine whether to forward the solicitation message. The condition(s) may be based on information received from one or more other relay WTRU(s). For example, the first relay WTRU may receive an announcement message from a second relay WTRU that includes the list of reachable WTRUs for the second relay WTRU. The list may include a source WTRU and/or a target WTRU. In some examples, the first relay WTRU may choose not to forward/broadcast the solicitation message(s) from the source WTRU(s). For example, the first relay WTRU may choose not to forward/broadcast the solicitation message(s) from the source WTRU(s) because the second relay WTRU can provide the source WTRU(s) with the desired relay service.

The link quality between the second relay WTRU and associated proximity WTRUs, (e.g., the link quality of neighboring relay WTRUs and discovered proximity (source) WTRUs) and/or the link quality between the first relay WTRU and its associated proximity WTRUs may determine whether the first relay WTRU broadcasts/forwards a solicitation message from one or more source WTRUs. For example, the first relay WTRU may choose to forward a solicitation message based on determining that the first relay WTRU is a better (e.g., the best) relay for this source WTRU. For example, if the source WTRU is reachable by both the first relay WTRU and the second relay WTRU, but the SD-RSRP to the source WTRU for the first relay WTRU is better than the reported SD-RSRP for the source WTRU from the second relay WTRU, the first relay WTRU may choose to forward the solicitation message.

In some examples, a threshold or offset for the SD-RSRP may be used. For example, the first relay WTRU may forward the discovery (e.g., solicitation) message if the SD-RSRP between the first relay WTRU and source WTRU is larger than the reported SD-RSRP between the source WTRU (or a subset of all reachable source WTRUs) and the second relay WTRU, for example, by some threshold (e.g., a delta) or offset.

The techniques described herein may impart some hysteresis, and/or avoid some discovery message transmissions (e.g., unnecessary/wasteful discovery message transmissions). The discovery message(s) may be transmitted if (e.g., only if) there may be a benefit to transmit the discovery message(s) (e.g., from a source WTRU perspective). Accordingly, unnecessary processing/reselection at source WTRUs may be reduced.

The timing/frequency of received discovery message(s) may be used to determine whether to forward a solicitation request from a source/source WTRU. For example, the first relay WTRU may receive a solicitation message from a source WTRU. The first relay WTRU may have received (e.g., recently received) an announcement message from a second relay WTRU. The source WTRU may be able to reach the second relay WTRU. The source WTRU may meet one or more conditions (e.g., link quality, service type, etc.). In this example, the first relay WTRU may choose to not forward the solicitation message from the source WTRU.

The decision of whether to forward discovery messages may be based on the relative frequencies of the source WTRU and/or discovery message reports from other relay WTRU(s) (e.g., the second relay WTRU). For example, if the first and second relay WTRUs can reach a source WTRU, and the second relay WTRU reports an announcement message with a higher frequency than the first relay WTRU, the first relay WTRU may choose not to forward solicitation message(s). For example, the first relay WTRU may choose not to forward solicitation message(s) since and the discovery/announcement message(s) from the second relay WTRU may be more updated.

The set of WTRUs from which the first relay WTRU receives discovery message may be same as the set of WTRUs listed in the announcement message from the second relay WTRU. The first relay WTRU may compare the measured SD-RSRP of the source WTRUs from which the first relay WTRU has received a discovery message to the RSRP of the source WTRUs in the announcement message.

The first relay WTRU may decide to forward the received discovery/solicitation message (or may decide to transmit its own discovery message with a list of reachable source WTRUs). For example, the first relay WTRU may determine to forward the discovery message if the minimum RSRP of the received discovery message is greater than the lowest RSRP listed in the announcement message. The first relay WTRU may determine to forward the discovery message if the minimum RSRP of the discovery message received from a source WTRU is greater than the lowest RSRP listed for that source WTRU in the announcement message.

The decision of whether to forward the message may be based on measurement criteria. For example, the decision of whether to forward the message may be based on a comparison of a mean, median, and/or maximum of RSRP measurements between discovery messages received from other relay WTRUs (e.g., the second relay WTRU) to RSRP values included in the announcement message.

The decision of whether to forward the message may be based on the relative or absolute location information of the first and second relay WTRUs. In an example, if the second relay WTRU (e.g., the relay WTRU from which the announcement message was received) has a different location ID (zone ID, coordinate(s), etc.) than the first relay WTRU, the first relay WTRU may (e.g., determine to) forward the discovery message.

The decision of whether to forward the message may be based on the availability of an established (e.g., already-established) unicast link between the second relay WTRU and a source WTRU. For example, the first relay WTRU may decide to forward a discovery message if the second relay WTRU (e.g., the relay WTRU transmitting the announcement message) has an established unicast connection to one or more of the source WTRUs in the list (e.g., the list transmitted in the announcement message).

The decision of whether to forward the message may be based on a resource pool. For example, a WTRU (e.g., the first relay WTRU) may determine to transmit/forward discovery messages from source WTRUs based on a resource pool with which the first relay WTRU receives other discovery messages (e.g., announcement messages from other relay WTRUs, solicitation messages from source WTRUs).

The first relay WTRU may choose to transmit/forward a discovery message based on a type and/or availability of a configured resource. The first relay WTRU may choose to transmit/forward a discovery message based on a priority of the discovery message (e.g., based on the priority of the discovery message satisfying a condition). For example, the first relay WTRU may determine the priority of a received discovery message based on content of the discovery message.

The resource pool may be associated with a priority or QoS of a discovery message. For example, certain discovery message priority or QoS types may be restricted to a set of resource pools or a subset of resources within a resource pool (e.g., a subset of time and/or frequency resources). Other (for e.g., lower) discovery message priority or QOS types may be mapped to a different set of resource pools or subset of resources within a resource pool.

The specific type/configuration of a resource pool may be associated with transmission or forwarding priority. For example, if the first relay WTRU is configured with a dedicated resource pool (e.g., only a dedicated resource pool), the first relay WTRU may choose to forward (e.g., always forward) received discovery messages (e.g., all received discovery messages). For example, if the first relay WTRU is configured with a shared resource pool (e.g., on a shared resource pool), other conditions may be used for deciding whether to forward an incoming discovery message.

If the first relay WTRU is configured with a shared resource pool (e.g., on a shared resource pool), and/or the incoming discovery message priority is below a threshold value, the first relay WTRU may determine whether to forward the discovery message based on whether resource pool usage (e.g., CBR/CR) is below a threshold.

The first relay WTRU may be configured to determine whether to forward the discovery message based on at least one of: a priority associated with the discovery message; or, a quality of service associated with the discovery message. For example, the first relay WTRU may be (pre)configured to forward a high priority discovery message (e.g., based on QoS or relay service ID of received discovery). This determination may be irrespective of the type of resource pools configured for discovery message transmission.

The QoS of the discovery message(s) (e.g., announcement message(s) from relay WTRU(s) and/or solicitation message(s) from remote/source WTRU(s), etc.) may be used to determine whether a discovery message should be forwarded/transmitted. For example, the first relay WTRU may compare the QOS of the relay service offered by the first relay WTRU to the QoS of the announcement message received from a second relay WTRU. The first relay WTRU may choose to forward the received discovery message if the service offered by the first relay WTRU is better than the QoS offered by the second relay WTRU.

The first relay WTRU may compare the QoS of the relay service offered by the first relay WTRU (and/or the QoS of the announcement message received from the second relay WTRU) to the QoS level requested by a remote/source WTRU in a discovery (solicitation) message. The first relay WTRU may choose to forward the received discovery message if the service offered by the first relay WTRU meets the QOS level requested by the source WTRU. The requested QoS level may be based on an absolute value. The requested QoS level may be based on a QoS threshold and/or range.

The first relay WTRU may choose not to forward a discovery message based on resource pool usage (e.g., measured by CBR and/or CR). The first relay WTRU may utilize CBR (and/or received signal strength indicator (RSSI)) to measure whether the channel occupancy for the first relay WTRU's configured resource pool(s) exceeds a (pre-)configured threshold in the sub-channels of the resource pool. The resource pool(s) may have different CBR and/or RSSI thresholds based on configuration type (e.g., shared or dedicated), the number of WTRUs sharing the resource pool, the priority of the discovery messages, the QoS of the discovery messages that may be transmitted on resource pools, and/or the like.

The first relay WTRU may adapt (e.g., modify) a discovery transmission of the first relay WTRU (e.g., behavior related to forwarding discovery messages and/or transmitting the WTRU's (own) discovery messages) based on channel occupancy (e.g., SL CR) generated by the first relay WTRU (e.g., the first relay WTRU itself). For example, if the first relay WTRU observes that the SL channel occupancy ratio (CR) (and possibly CBR) are indicative of high load, the first relay WTRU may (e.g., temporarily) cease forwarding discovery messages. For example, the first relay WTRU may cease forwarding discovery messages for a set duration of time before resuming transmissions.

The first relay WTRU may choose to not forward a discovery message if the first relay WTRU detects a change in the first relay WTRU's channel conditions. For example, conditions of the first relay WTRU may include: QoS, number of (reachable) source WTRUs, number of WTRUs with which the first relay WTRU has an active/ongoing unicast connection, the load of the first relay WTRU (e.g., based on maximum/current supportable data rate, bandwidth usage, latency, QoS, etc.), the RSRP from source WTRUs, and/or the like. The change may be based on the difference between announcement message receptions and/or an average change over several received announcement messages (e.g., in a time window).

The first relay WTRU may choose to not forward discovery messages, temporarily pause forwarding discovery messages, or reduce the frequency with which the first relay WTRU forwards discovery messages based on congestion (e.g., based on CBR and/or CR). For example, the first relay WTRU may choose to reduce the frequency of discovery message forwarding for one or more other relay WTRU(s) that send announcements with a higher frequency than other relay WTRU(s).

The first relay WTRU may choose to reduce the frequency of discovery message forwarding based on the set of WTRUs that the other relay WTRU(s) serve. For example, if two relay WTRUs (e.g., from which the first relay WTRU has received announcement message) have the same source WTRU list, the first relay WTRU relay may choose to transmit one (e.g., only one) of these announcement messages. For example, the first relay WTRU may choose to transmit the less frequent announcement message. The first relay WTRU may choose to transmit the announcement messages in a round robin fashion.

If the congestion improves (e.g., CBR and/or CR drops below some threshold), the first relay WTRU may revert to previous forwarding behavior. The first relay WTRU may determine that congestion has improved based on considerations for discovery service message type/ID/priority, whether a message with a similar ID/type was forwarded more recently than one with a different ID/type, and/or the like.

The first relay WTRU may determine whether to forward the discovery message based on whether the first relay WTRU can adapt one or more transmissions parameter(s) (e.g., while still satisfying discovery message QoS specifications/requirements). For example, the transmission parameter(s) may include the modulation coding scheme (MCS), number of frequency resources (e.g., subchannels), transmission power, frequency of transmissions/retransmissions (e.g., to limit the CR), and/or the like.

Transmission parameters of a relay WTRU's discovery message may depend on information received in announcement messages from other relay WTRUs. For example, a relay WTRU may determine/modify transmission parameters associated with discovery messages (e.g., either forwarding of a source WTRU's discovery message, or transmission of its own announcement message) based on information received from another relay WTRU's announcement message.

An example transmission parameter may be a transmit power of the discovery message. The relay WTRU may be configured with a set or range of transmission power levels based on a type of discovery service message. For example, the relay WTRU may pick an appropriate power level based on the type of discovery service message that the relay WTRU transmits.

The transmission power level may be determined based on the set of resources on which the discovery messages were received. For example, the transmission power level may be determined as a function of the set of resources on which the discovery messages were received. For example, the transmission power level may be determined based on a number of subchannels, size of subchannels, time-frequency resources, resource pool (e.g., shared and/or dedicated), load/resource usage (e.g., as measured by CBR), transmission resource usage (e.g., as measured by CR), MCS, and/or the like.

The relay WTRU may use location information of the other relay WTRU to modify/adjust the relay WTRU's transmission power. For example, if the relay WTRU is in a different location (e.g., zone ID), the relay WTRU may modify (e.g., increase) its transmission power. For example, if the distance between the two relay WTRUs is greater than a threshold, the WTRU may modify its transmission power.

The relay WTRU may modify its transmission parameters based on the size of a discovery message received from another relay WTRU.

The relay WTRU may apply an offset based on whether the discovery message is an announcement from the relay WTRU (e.g., generated by the relay WTRU). In an examples, the relay WTRU may apply an offset based on whether the discovery message is being forwarded from another source WTRU. The relay WTRU may apply an offset based on content of the discovery message (e.g., service type, priority, or the like of (another) relay WTRU's received announcement message).

An example transmission parameter may be a resource pool used to transmit the discovery message (either dedicated versus shared resource pool).

The type of resources used by the relay WTRU to transmit/forward a discovery message may depend on the resource pool configurations of a source WTRU (e.g., from which the relay WTRU receives a discovery message) and/or the other relay WTRU (e.g., from which the relay WTRU receives an announcement message). For example, if the relay WTRU knows that it has received a discovery message on a dedicated resource pool of another relay WTRU, the relay WTRU may determine to prioritize use of a dedicated resource pool for forwarding purposes. If the relay WTRU determines that it has received a discovery message on a dedicated resource pool of another relay WTRU, the relay WTRU may determine to use a shared pool for transmitting discovery messages generated by the relay WTRU. The type of resources used by the relay WTRU to transmit/forward a discovery message may depend on relative priorities of forwarding discovery message compared to transmitting discovery messages generated by the relay WTRU.

The relay WTRU may choose to prioritize specific discovery messages based on a type/configuration of resource pools. The relay WTRU may choose to prioritize specific discovery messages based on a resource pool usage (e.g., CBR/CR). For example, the relay WTRU may modify its transmitting/forwarding behavior based on past determinations of resource pool type/configuration and/or prioritization. The relay WTRU may choose to prioritize a discovery message based on a type of discovery message transmission. The relay WTRU may determine whether to prioritize certain transmissions based on whether the relay WTRU previously prioritized forwarding discovery messages from other WTRUs or transmitting its own discovery announcements (e.g., discovery announcements generated by the relay WTRU)).

An example transmission parameter may be a frequency/carrier of the resources used to transmit discovery messages.

The frequency/carrier used to transmit discovery messages may be based on the size of the discovery message, the available transmission power at the relay WTRU (e.g., power headroom), the channel quality (e.g., channel quality indicator (CQI), pathloss, etc.), the available bandwidth on each carrier, discovery model (transmitting/forwarding a model A or B discovery message), and/or the like.

An example transmission parameter may be a frequency of transmission (e.g., how often discovery messages are forwarded/transmitted).

The relay WTRU may choose to prioritize (or temporarily reduce) the frequency of discovery message transmissions based on the relative frequency of discovery message receptions compared to transmission of discovery messages generated by the relay WTRU. The relay WTRU may choose to prioritize (or temporarily reduce) the frequency of discovery message transmissions based on the relative priorities of various discovery message types. The relative priorities may be based on service type/QoS, the number of other WTRUs that the relay WTRU can reach compared to the number of other WTRUs from which the relay WTRU received an announcement, the relative link qualities of discoverable WTRUs, coverage area, the number of active (e.g., already established) relay connections, and/or the like.

The relay WTRU may choose to transmit the discovery message with a lower frequency for a period of time. For example, the WTRU may choose to transmit the discovery message with a lower frequency based on information in a received announcement message (e.g., from another relay WTRU).

For example, if the relay WTRU serves the same set/subset of source WTRUs as the other relay WTRU, but the RSRP of the relay WTRU is lower than that of the other relay WTRU (e.g., as indicated in the announcement message), the relay WTRU may choose to temporarily reduce its frequency of transmission. The relay WTRU may determine to resume its normal transmission (e.g., at its original transmission frequency) based on a change in the RSRP measurements and/or a timer. The transmission frequency may be based on various criteria described herein.

An example transmission parameter may be timing or an offset in time. The timing or offset in time may be associated with periodic transmission, for example.

The relay WTRU may select the timing of transmission for its discovery message (e.g., a discovery message generated by the relay WTRU) based on the timing of other relay WTRUs' discovery message transmissions. For example, the relay WTRU may select a transmission time such that the offset between its transmission and that of the other WTRU's transmission is maximized. The relay WTRU may select a transmission time such that the offset between its transmission and that of the other WTRU's transmission is maximized when the other WTRU is serving same set or subset of source WTRUs. The relay WTRU may select a transmission time such that the offset between its transmission and that of the other WTRU's transmission is maximized when the relay WTRU and the other WTRU(s) are in the same location area.

The offset may depend on discovery message characteristics. For example, the offset may depend on types and/or QoS of discovery service(s) offered by the relay WTRU and/or the other WTRU, relative frequency/periodicities of transmissions from the relay WTRU and the other WTRU, coverage of the relay WTRU and/or the other WTRU (e.g., in terms of source WTRUs covered, area of coverage, degree of overlap between coverage areas/zones, etc.), and/or the like (including similar mechanisms discussed herein).

An example transmission parameter may be actual resources used within the resource pool.

The set of resources used (e.g., time and/or frequency resources) may depend on discovery message transmission characteristics (e.g., Model A or Model B, forwarding messages compared to transmitting messages generated by the relay WTRU, discovery message type, discovery message frequency, and/or the like). For example, a subset of subchannels may be specified (e.g., dedicated) for transmission of discovery messages generated by the relay WTRU, whereas another subset of resources may be specified for forwarding discovery messages from other WTRUs. A common set of subchannels may be shared/used by both types of transmissions. The relay WTRU may select which type of discovery message may use a given resource based on various criteria described herein.

The set of resources available may change based on link quality (e.g., achievable MCS), transmission power/power headroom, WTRU capability, relay load, and/or the like. The frequency with which resources are allocated/available may depend on characteristics of the discovery message transmission.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-14. (canceled)

15. A first wireless transmit/receive node (WTRU) comprising:
a processor configured to:
receive an announcement message from a second WTRU, wherein the announcement message indicates a set of one or more source WTRUs associated with the second WTRU;
receive a discovery message from a source WTRU associated with the first WTRU;
determine whether the source WTRU is in the set of one or more source WTRUs associated with the second WTRU; and
on a condition that the source WTRU is not in the set of one or more source WTRUs associated with the second WTRU, forward the discovery message to the second WTRU.

16. The first WTRU of claim 15, wherein the processor is further configured to, on a condition that the source WTRU is in the set of one or more source WTRUs, determine whether to forward the discovery message further based on at least one of: a transmission characteristic of the discovery message or a location identifier of the source WTRU.

17. The first WTRU of claim 16, wherein the transmission characteristic is a minimum RSRP of the discovery message, and wherein the processor being configured to determine whether to forward the discovery message comprises the processor being configured to, on a condition that the minimum RSRP of the discovery message is greater than a lowest RSRP indicated in the announcement message, forward the discovery message to the second WTRU.

18. The first WTRU of claim 16, wherein the processor being configured to determine whether to forward the discovery message comprises the processor being configured to, on a condition that the location identifier of the source WTRU is different from a location identifier of the first WTRU, forward the discovery message to the second WTRU.

19. The first WTRU of claim 16, wherein the processor being configured to determine whether to forward the discovery message is further based on at least one of: a priority associated with the discovery message, or a quality of service associated with the discovery message.

20. The first WTRU of claim 15, wherein the discovery message is a first discovery message, and the processor is further configured to, on a condition that the first WTRU determines not to forward the first discovery message:
generate a second discovery message associated with the first WTRU; and
transmit the second discovery message to a remote WTRU.

21. The first WTRU of claim 15, wherein the discovery message is a first discovery message, the set of one or more source WTRUs associated with the second WTRU comprises a first set of one or more source WTRUs, and the processor is further configured to:
generate a second discovery message associated with the first WTRU, wherein the second discovery message indicates a second set of one or more source WTRUs associated with the first WTRU, and wherein the second set of one or more source WTRUs comprises source WTRUs from which the first WTRU has received a message during a window of time or via a dedicated resource; and
transmit the second discovery message to a remote WTRU.

22. The first WTRU of claim 15, wherein the discovery message is a first discovery message, the set of one or more source WTRUs associated with the second WTRU comprises a first set of one or more source WTRUs, and the processor is further configured to:
generate a second discovery message associated with the first WTRU, wherein the second discovery message indicates a second set of one or more source WTRUs associated with the first WTRU, the second set of one or more source WTRUs comprises a maximum number of source WTRUs, and the maximum number of source resources is determined based on a channel busy ratio (CBR) associated with the first WTRU, a channel occupancy ratio (CR) associated with the first WTRU, a load associated with the first WTRU, or capability associated with the first WTRU; and
transmit the second discovery message to a remote WTRU.

23. The first WTRU of claim 15, wherein the discovery message is a first discovery message, and the processor is further configured to:
generate a second discovery message associated with the first WTRU, wherein the second discovery message indicates one or more of: a WTRU identifier of the first WTRU, a unicast link established at the first WTRU, or a location of the first WTRU; and
transmit the second discovery message to a remote WTRU.

24. The first WTRU of claim 15, wherein the discovery message is a first discovery message, and the processor is further configured to:
generate a second discovery message associated with the first WTRU, wherein the second discovery message comprises an indication of the source WTRU associated with the first WTRU, and an indication of one or more of: a unicast link associated with the source WTRU, a network coverage status associated with the source WTRU, a connected state of the source WTRU, or a cell to which the source WTRU is connected; and
transmit the second discovery message to a remote WTRU.

25. A method, performed by a first wireless transmit/receive node (WTRU), the method comprising:
receiving an announcement message from a second WTRU, wherein the announcement message indicates a set of one or more source WTRUs associated with the second WTRU;
receiving a discovery message from a source WTRU associated with the first WTRU;
determining whether the source WTRU is in the set of one or more source WTRUs associated with the second WTRU; and
on a condition that the source WTRU is not in the set of one or more source WTRUs associated with the second WTRU, forwarding the discovery message to the second WTRU.

26. The method of claim 25, wherein the method further comprises, on a condition that the source WTRU is in the set of one or more source WTRUs, determining whether to forward the discovery message further based on at least one of: a transmission characteristic of the discovery message or a location identifier of the source WTRU.

27. The method of claim 26, wherein the transmission characteristic is a minimum RSRP of the discovery message, and wherein determining whether to forward the discovery message comprises on a condition that the minimum RSRP of the discovery message is greater than a lowest RSRP indicated in the announcement message, forward the discovery message to the second WTRU.

28. The method of claim 26, wherein determining whether to forward the discovery message comprises on a condition that the location identifier of the source WTRU is different from a location identifier of the first WTRU, forward the discovery message to the second WTRU.

29. The method of claim 26, wherein determining whether to forward the discovery message is further based on at least one of: a priority associated with the discovery message, or a quality of service associated with the discovery message.

30. The method of claim 25, wherein the discovery message is a first discovery message, and the method further comprises, on a condition that the first WTRU determines not to forward the first discovery message:
generate a second discovery message associated with the first WTRU; and
transmit the second discovery message to a remote WTRU.

31. The method of claim 25, wherein the discovery message is a first discovery message, the set of one or more source WTRUs associated with the second WTRU comprises a first set of one or more source WTRUs, and the method further comprises:
generating a second discovery message associated with the first WTRU, wherein the second discovery message indicates a second set of one or more source WTRUs associated with the first WTRU, and wherein the second set of one or more source WTRUs comprises source WTRUs from which the first WTRU has received a message during a window of time or via a dedicated resource; and
transmitting the second discovery message to a remote WTRU.

32. The method of claim 25, wherein the discovery message is a first discovery message, the set of one or more source WTRUs associated with the second WTRU comprises a first set of one or more source WTRUs, and the method further comprises:
generating a second discovery message associated with the first WTRU, wherein the second discovery message indicates a second set of one or more source WTRUs associated with the first WTRU, the second set of one or more source WTRUs comprises a maximum number of source WTRUs, and the maximum number of source resources is determined based on a channel busy ratio (CBR) associated with the first WTRU, a channel occupancy ratio (CR) associated with the first WTRU, a load associated with the first WTRU, or capability associated with the first WTRU; and
transmitting the second discovery message to a remote WTRU.

33. The method of claim 25, wherein the discovery message is a first discovery message, and the method further comprises:
generating a second discovery message associated with the first WTRU, wherein the second discovery message indicates one or more of: a WTRU identifier of the first WTRU, a unicast link established at the first WTRU, or a location of the first WTRU; and
transmitting the second discovery message to a remote WTRU.

34. The method of claim 25, wherein the discovery message is a first discovery message, and the method further comprises:
generating a second discovery message associated with the first WTRU, wherein the second discovery message comprises an indication of the source WTRU associated with the first WTRU, and an indication of one or more of: a unicast link associated with the source WTRU, a network coverage status associated with the source WTRU, a connected state of the source WTRU, or a cell to which the source WTRU is connected; and
transmitting the second discovery message to a remote WTRU.
